(19) United States
(12) Patent Application Publication
(10) Pub. No.: US 2001/0039734 A1
(43) Pub. Date: Nov. 15, 2001

(54) SHAVING APPARATUS

(76) Inventors: SIMON E. KADIJK, DRACHTEN (NL); ERIC N.J.O. QUINT, EINDHOVEN (NL); HIDDO H. HANENBURG, URETERP (NL)

Correspondence Address: CORPORATE PATENT COUNSEL, U S PHILIPS CORPORATION, 580 WHITE PLAINS ROAD, TARRYTOWN, NY, 10591

(21) Appl. No.: 09/024,631

(22) Filed: Feb. 17, 1998

(30) Foreign Application Priority Data
Feb. 17, 1997 (EP) 97200432.9

(51) Int. Cl. B26B 19/14

(52) U.S. Cl. 30/43.6; 30/346.51

(57) ABSTRACT

A shaving apparatus comprises at least two shaving heads (3), each having an external cutting member (4) and an internal cutting member (5) which is drivable relative to this external cutting member, each external cutting member having shaving fields (7, 8-19, 20-21, 22) with hair-entry apertures (9, 10) of different types, including one type for cutting long hairs (pre-shaving) and one type for cutting short hairs (close shaving). In order to improve the shaving performance the shaving fields (7, 8-19, 20-21, 22) of the same type of two adjacent external cutting members (4) are directed towards one another. Preferably, the shaving fields (7, 19, 21) for short hairs are situated in a central area of the shaving apparatus and the shaving fields (8, 20, 22) for long hairs are situated around the first-mentioned fields or at least in an area near the periphery of the shaving apparatus.

The invention relates to a shaving apparatus comprising at least two shaving heads, each having an external cutting member and an internal cutting member which is drivable relative said external cutting member, each external cutting member having shaving fields with hair-entry apertures of different types, including one type for cutting long hairs and one type for cutting short hairs.

Such a shaving apparatus is known from U.S. Pat. No. 3,564,715 (PHN 2515). In this shaving apparatus the external cutting member has a plurality of comparatively small shaving fields with two different types of hair-entry apertures, i.e. slit-shaped hair-entry apertures and round hair-entry apertures. The different fields in the cutting member are arranged in an alternating fashion. The slit-shaped radially oriented hair-entry apertures also enable long hairs to be caught and cut off or trimmed satisfactorily. However, the skin can penetrate deeper into the slit-shaped hair-entry apertures (bulge through) so that, in order to preclude irritation of the skin, a larger thickness of the external cutting member has been selected at this location. The shaving fields with the round and small hair-entry apertures enable the hairs to be severed as closely as possible because at these locations the external cutting member has a smaller thickness than at the locations of the shaving fields with the slits. The smaller hair-entry apertures ensure that no irritation of the skin occurs. Thus, the thicker cutting-member portions with the slit-shaped hair-entry apertures provide a kind of coarse shave or pre-shave and the thinner portions provide a close or final shave.

It is an object of the invention to improve a shaving apparatus of the type defined in the opening paragraph, so as to improve the shaving performance, i.e. so as to achieve that long hairs are caught and trimmed properly and short hairs are severed as closely as possible, this in conjunction with skin-friendly shaving, i.e. minimal irritation of the skin.

To this end, the shaving apparatus in accordance with the invention is characterized in that the shaving fields of the same type of two adjacent external cutting members are directed towards one another.

Viewed over the entire shaving field, which is formed by the overall area of all the external shaving fields, this gives the effect of a central shaving field with hair-entry apertures of the same type and outer shaving fields with hair-entry apertures of another type. Larger adjacent shaving fields having hair-entry apertures of the same type are obtained than in accordance with the above-mentioned U.S. Pat. No. 3,564,715. It has been found that such an arrangement of shaving fields results in a distinct improvement of the shaving performance.

A preferred embodiment is characterized in that the shaving fields for cutting long hairs are remote from one another. The shaving movements over the skin are such that hairs to be severed newly first come into contact with the shaving fields situated at the outside, viewed from the center of the overall shaving area. It is therefore favorable when in particular long hairs are caught and trimmed off at this location. Subsequently, the short hairs or hairs already trimmed are cut off as closely as possible in the shaving fields which are directed towards one another, i.e. form the afore-mentioned central shaving field.

In another embodiment the shaving fields for cutting long hairs can be directed towards one another. Short hairs are now severed in the afore-mentioned outer shaving fields. This has the advantage that in the case of bearded persons, who effect shaving along the beard edge, long hairs at the beard edge are not caught. In the example mentioned in the preceding paragraph this could be the case, which might result in a painful kind of hair tugging.

Preferably, the hair-entry apertures for cutting long hairs are substantially radially oriented slits which extend up to the edge of the external cutting member, and those for cutting short hairs are small round or oval apertures, the thickness of the external cutting member at the location of the slits being greater than at the location of the small apertures.

In principle, this has already been described in U.S. Pat. No. 3,564,715. Slits which extend up to the edge of the cutting member promote the easy entry of hairs. However, as already stated hereinbefore, the skin can bulge through further than in small apertures, so that the thickness of the cutting member at the location of the slits should be greater in order to preclude irritation of the skin. At the location of the small hair-entry apertures the cutting member can be thinner so that at this location the hairs can be severed as closely as possible, yet without causing any irritation of the skin.

The hair-entry apertures for cutting long hairs can, for example, have the shape of a tuning fork. It has been found that shaving heads with such a pattern of hair-entry apertures perform well for persons with heavy beards.

When the hair-entry apertures for cutting long hairs are formed by a double row of slits the shaving apparatus is better suited for persons with a more sensitive skin.

However, it is alternatively possible to form all the hair-entry apertures of an external cutting member as substantially radially oriented slits, the slits of a shaving field of one type being wider than those of a shaving field of the other type. Thus, for example the slits situated in outer shaving fields are wider than the slits situated in the central shaving field. The greater width of the slits at the periphery allows the long hairs to be caught more easily. The slits in the central field should have such a width that no irritation of the skin occurs.

A further embodiment is characterized in that the shaving heads are pivotable in such a manner that the shaving surface defined by the surfaces of all the external cutting members can be adjusted to adopt a concave or a convex shape. When in a shaving apparatus the shaving fields for cutting long hairs are directed towards one another and the shaving surface is set to an outwardly convex position the effect of the final shave is promoted, while in the case that in such a shaving apparatus the shaving surface is set to an inwardly concave position the pre-shave effect is enhanced. It is to be noted that making a shaving surface of a rotary shaving apparatus concave or convex and the means for this are known per se, for example from WO-A-9602368 (PHN 14930), or U.S. Pat. No. 4,318,223 (PHN 9600), or U.S. Pat. No. 4,168,570 (PHN 8748).

Another embodiment is characterized in that the external cutting members are rotatable through 180°. This makes it possible to interchange the positions of the shaving fields for pre-shaving and final shaving.

The shaving apparatus in accordance with the invention thus has a number of different functions, which make it very suitable for persons having particular wishes as regards shaving (tailor-made). For example, persons with a sensitive skin can select a shaving position which minimizes irritation. Other persons having a less sensitive skin and wishing to minimize the shaving time can select another position.

Some embodiments of the invention will now be described in more detail, by way of examples, with reference to the drawings. In the drawings:

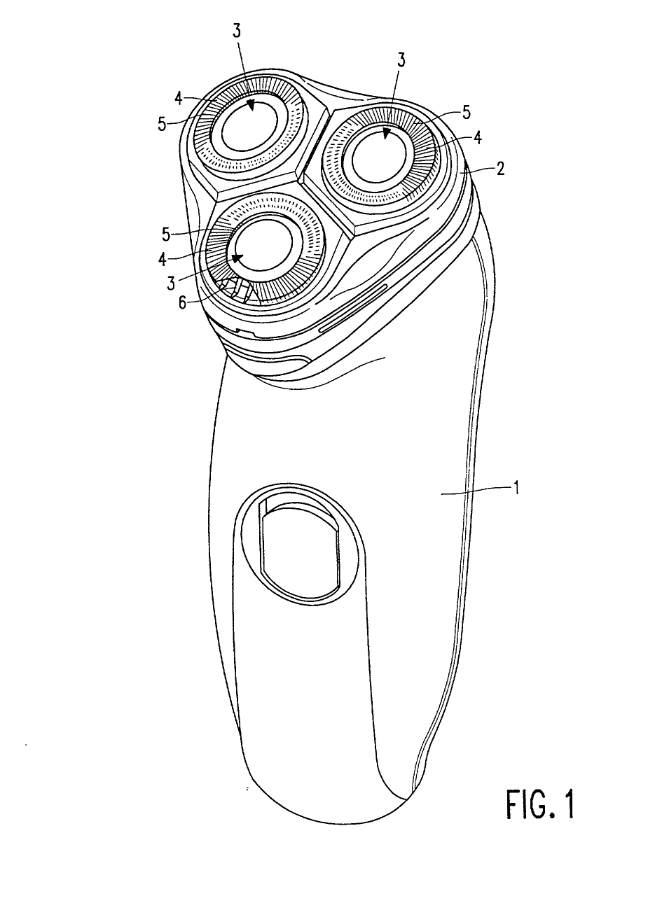

FIG. 1 is a perspective view of a shaving apparatus having three shaving heads,

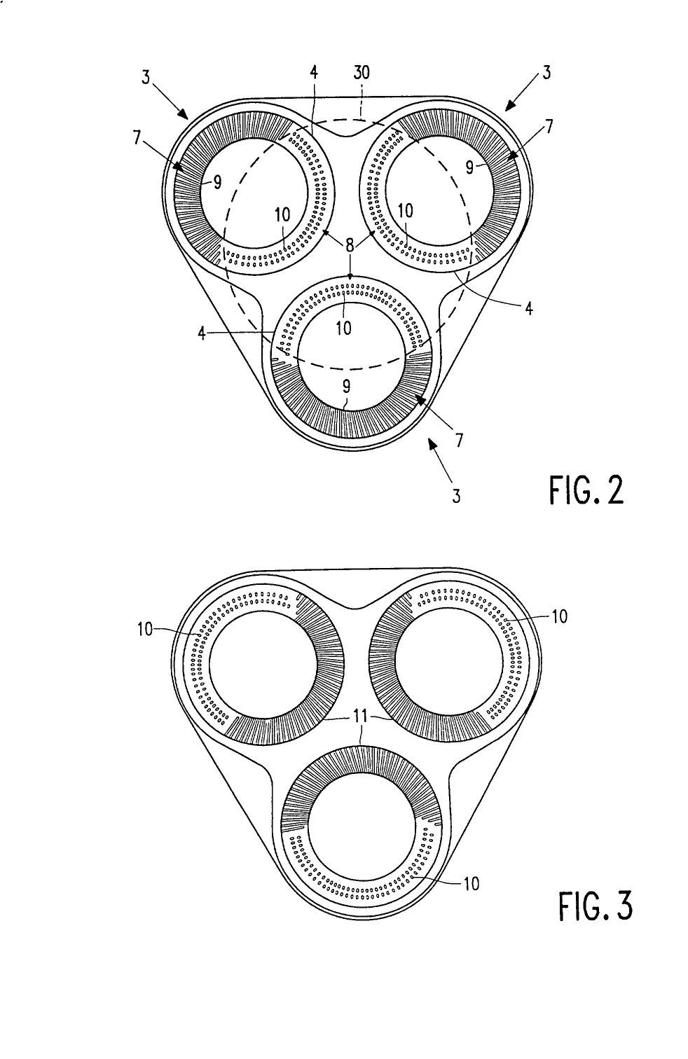

FIG. 2 is a plan view of a triple-head shaving apparatus, in which the shaving fields with hair-entry apertures for cutting long hairs are remote from one another,

FIG. 3 is a plan view similar to that in FIG. 2 but with hair-entry apertures for cutting long hairs being directed towards one another,

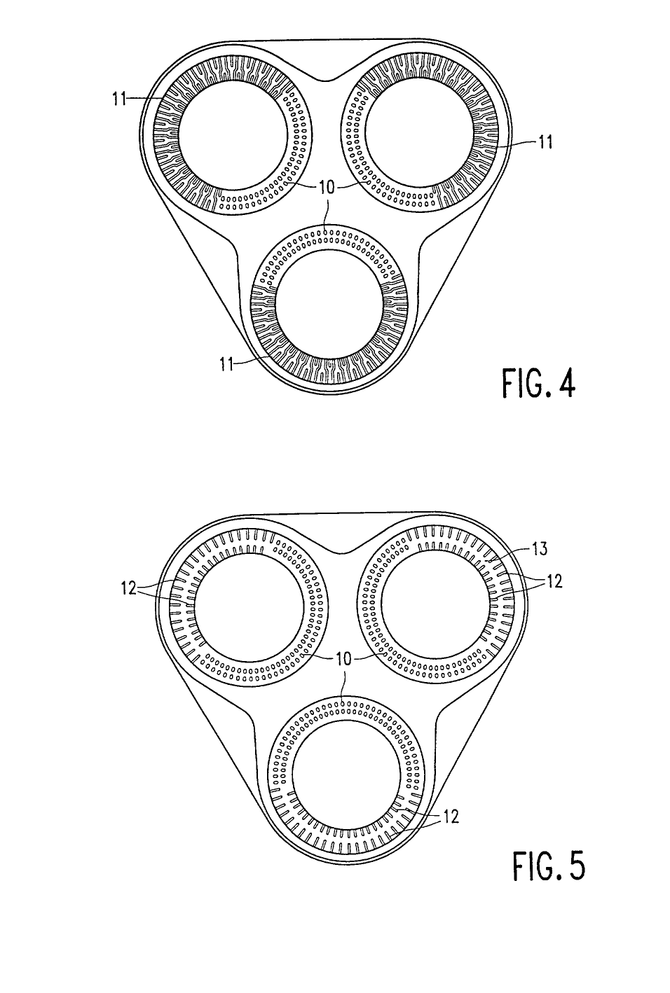

FIGS. 4, 5 and 6 show some other examples of patterns of hair-entry apertures in a triple-head shaving apparatus,

FIGS. 7 and 8 are side views of a triple-head shaving apparatus, in which the shaving-head surface has a convex shape and a concave shape, respectively,

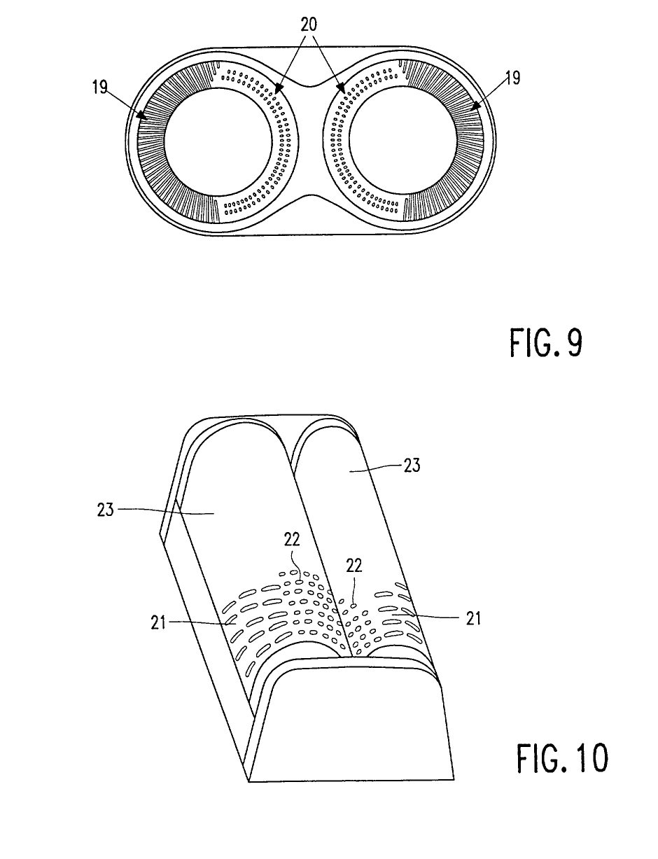

FIG. 9 is a plan view of a two-head rotary shaving apparatus in accordance with the invention, and

FIG. 10 is a plan view of a two-head vibratory shaving apparatus in accordance with the invention.

The rotary shaving apparatus shown in FIG. 1 has a housing 1 with a shaving-head holder 2 which is detachable from the housing or hingeable with respect to the housing. In the holder three shaving heads 3, also referred to as cutting units, are mounted, which heads each comprise an external hair-cutting member 4 with hair-entry apertures 5 and an internal hair-cutting member 6 which is rotationally drivable with respect to said external cutting member. The internal hair-cutting members are driven by a motor, not shown, in the housing of the shaving apparatus.

The external hair-cutting members 4 of the shaving heads 3 of the shaving-head holder 2 shown in FIG. 2 each have two shaving fields 7, 8 with different types of hair-entry apertures, i.e. one type with substantially radially oriented slits 9 and another type with small more or less round apertures 10. In reality, the last-mentioned apertures are substantially reniform. The two shaving fields are substantially equal in size. The shaving fields 7 with the slits are mainly intended for cutting or trimming long hairs, while the shaving fields 8 with the small apertures are intended for cutting the hairs as closely as possible. The slits are better capable of catching long hairs than the small apertures. However, the slits are more likely to cause irritation of the skin than the small apertures. Therefore, the thickness of the hair-cutting member at the location of the slits is greater than at the location of the small apertures. Thus, the shaving fields with the slits provide a kind of pre-shave effect and the shaving fields with the small apertures provide a close shave. In FIG. 2 the shaving fields with the slits 9 of the three cutting members, i.e. the fields for properly catching and trimming long hairs, are remote from one another, while the shaving fields 8 with the small apertures 10, i.e. for severing short hairs as closely as possible, are directed towards one another.

In FIG. 3 the orientation of the shaving fields has been rotated through 180° with respect to the shaving fields in FIG. 2. A shaving apparatus with such an orientation of the shaving fields is better suitable for a person who wish to shave an area adjacent the beard edge. The 180° rotation of the external cutting members 4 can be effected simply by the user by removing the cutting units 3 from the holder 2 and replacing them in the holder in a position rotated through 180°. Obviously, the cutting units should be locked against rotation.

FIGS. 4-6 shows some other shapes of hair-entry apertures. In FIG. 4 the slit-shaped apertures are shaped as tuning forks 11. These shaving heads are found to be more suitable for persons with heavy beards.

In FIG. 5, on the other hand, the hair-entry apertures for pre-shaving take the form of a double row of slits 12. Owing to the presence of an annular ridge 13 between the two rows of slits the external cutting member supports the skin more effectively at the location of the slits than in the case of the cutting member shown in FIG. 2. In the present example the shaving fields for final shaving are approximately twice as large as the shaving fields for pre-shaving. This type is better suited for persons with a sensitive skin. In the examples of FIGS. 4 and 5 the final-shaving fields 8 are the same as shown in FIG. 2, i.e. with small apertures 10.

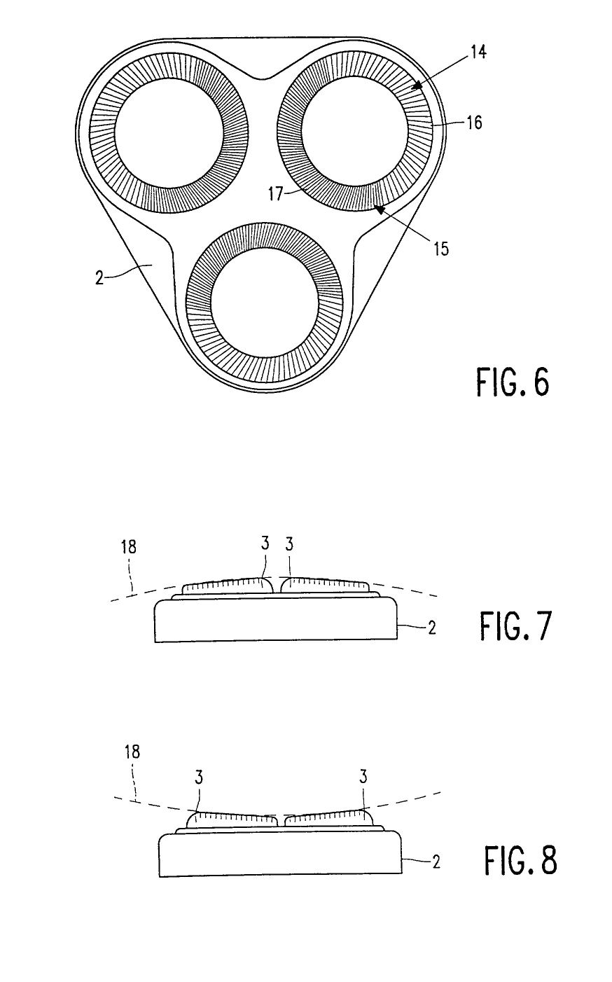

In FIG. 6 all the hair-entry apertures, i.e. both those for long hairs and for short hairs, are shaped as slits. The shaving fields 14 for long hairs, however, have wide slits 16 and the shaving fields 15 for short hairs have narrow slits 17. In these examples it is obviously also possible to rotate the cutting members through 180°.

FIGS. 7 and 8 illustrate the effect of making the total shaving surface concave and convex. The total shaving surface may be defined as approximately the surface in which the individual shaving surfaces of the external cutting members extend. In these Figures the total shaving surface bears the reference numeral 18. The cutting members are pivotable in the shaving heads in such a manner that the parts of the cutting members with the hair-entry apertures which are directed towards one another can be pushed up simultaneously, which results in a kind of outwardly convex shaving surface (FIG. 7). Conversely, the parts of the cutting members with the outer hair-entry apertures can be pushed up, which results in a kind of inwardly concave shaving surface (FIG. 8). This promotes or reduces a certain shaving effect. Mechanisms for adjusting the cutting members are known per se.

FIG. 9 shows the invention applied to a two-head rotary shaving apparatus. The shaving heads have two different types of shaving fields 19, 20 for pre-shaving and final shaving, fields of the same type being directed towards one another (20) and being remote from one another (19), respectively.

Finally, FIG. 10 shows another example of the invention applied to a two-head shaving apparatus of the vibratory type. Shaving fields 21 with slit-shaped hair-entry apertures for catching long hairs are situated at the peripheries of the shear foils, i.e. remote from one another. The shaving fields 22 with the small apertures for short hairs are situated in the central area. The last-mentioned shaving fields are consequently directed towards one another. The thickness of the shear foil 23 (external cutting member) at the location of the shaving field 21 with the slit-shaped hair-entry apertures is greater than the thickness at the location of the shaving field 22 with the small apertures. The shaving fields 21 with the slit-shaped apertures can also be directed towards one another by replacing the shear foils or the shaving heads, either with or without the internal cutting members.

As an alternative to the replacement of the shear foils it is possible to make the two shear foils 23 adjustable, as described in U.S. Pat. No. 5,459,927 (PHO 93.515). In that case the shear foils must be provided with three shaving fields, i.e. two of the same type and one of the other type interposed between them.

The external cutting members (shear foils) are preferably manufactured by means of an electrochemical machining process (ECM). Such a process is carried out in an electrolytic solution of high ionic strength. The external cutting member to be processed then functions as the anode and the electrode of the ECM apparatus as the cathode. During electrochemical machining an electric current flows between the anode and the cathode. The electrode functions as the shaping tool for the formation of the slits and other apertures. During the process the cutting member arranged as the anode dissolves at the locations where the slits and other apertures must be formed as metal hydride(s), hydrogen being produced on the electrode surface. The difference in thickness of the cutting member can also be obtained by means of this electrochemical machining method by choosing the appropriate tools.

It will be evident that the invention can also be applied to, for example, a four-head shaving apparatus. Furthermore, the 180° rotation of the cutting members can also be effected by means of some actuating mechanism. Obviously, many variants of hair-entry apertures are possible for catching and trimming long hairs and cutting short hairs. The cutting member can be obtained not only by means of said electrochemical machining but also by means of a laser-machining process or an etching process.

1. A shaving apparatus comprising at least two shaving heads, each having an external cutting member and an internal cutting member which is drivable relative said external cutting member, each external cutting member having shaving fields with hair-entry apertures of different types, including one type for cutting long hairs and one type for cutting short hairs, characterized in that the shaving fields of the same type of two adjacent external cutting members are directed towards one another.

2. A shaving apparatus as claimed in claim 1, characterized in that the shaving fields for cutting long hairs are remote from one another.

3. A shaving apparatus as claimed in claim 1, characterized in that the shaving fields for cutting long hairs are directed towards one another.

4. A shaving apparatus as claimed in any one of the preceding claims, characterized in that the hair-entry apertures for cutting long hairs are substantially radially oriented slits which extend up to the edge of the external cutting member, and those for cutting short hairs are small round or oval apertures, the thickness of the external cutting member at the location of the slits being greater than at the location of the small apertures.

5. A shaving apparatus as claimed in claims 2 and 4, characterized in that the hair-entry apertures for cutting long hairs are shaped as tuning forks.

6. A shaving apparatus as claimed in claims 2 and 4, characterized in that the hair-entry apertures for cutting long hairs are formed by a double row of slits.

7. A shaving apparatus as claimed in claim 1, characterized in that all the hair-entry apertures of the external cutting member are substantially radially oriented slits, the slits of one type of shaving field being wider than those of the other type of shaving field.

8. A shaving apparatus as claimed in any one of the preceding claims, characterized in that the shaving heads are pivotable in such a manner that the shaving surface defined by the surfaces of all the external cutting members can be adjusted to adopt a concave or a convex shape.

9. A shaving apparatus as claimed in any one of the preceding claims, characterized in that the external cutting members are rotatable through 180°.

10. A method of manufacturing an external cutting member of a shaving apparatus as claimed in any one of the preceding claims, characterized in that the external cutting member is manufactured by means of an electrochemical machining process.

11. A cutting member manufactured in accordance with the method as claimed in claim 10.
